(19) United States
(12) Patent Application Publication
(10) Pub. No.: US 2026/0124628 A1
(43) Pub. Date: May 7, 2026

(54) ATOMIZING AIR NOZZLE ASSEMBLY

(71) Applicant: LANGEMAN MANUFACTURING LIMITED, Kingsville (CA)

(72) Inventors: Gary D. Langeman, Naples, FL (US); Harpreet Singh Bassan, Leamington (CA)

(73) Assignee: LANGEMAN MANUFACTURING LIMITED, Kingsville, ON (CA)

(21) Appl. No.: 18/934,729

(22) Filed: Nov. 1, 2024

(51) Int. Cl. B05B 7/04

(52) U.S. Cl. CPC B05B 7/0475

(57) ABSTRACT

An air nozzle for a spray gun with a fluid inlet and an air inlet and a barrel having fluid and air passageways. The nozzle includes a fluid tip and an air cap, the fluid tip comprising a fluid tip chamber that sealingly encompasses an end of the fluid tube and an orifice to allow fluid passing to pass into the fluid tip chamber and out the orifice. The air cap receives an end of the fluid tip, and attaches to the end of the barrel, and has a channel to receive air from the barrel passageways and pass the air to a swirl chamber in the air cap having an annular opening surrounding the fluid tip orifice. The air cap has vanes extending into the swirl chamber configured to redirect the air from an axial flow to a radial flow before exiting the air cap though the annular opening.

### FIELD OF THE INVENTION

The present invention relates to devices for applying coating materials to surfaces.

### BACKGROUND OF THE INVENTION

This invention relates to a device for applying coating materials, such as, for example, paints, epoxies, polymers, and the like. In particular, the invention relates to a dispensing device or gun for application of liquid materials which must be atomized and delivered in a spray pattern.

The invention is particularly suited for applications which require the liquid coating material to be dispensed and applied evenly, and where merely pouring the liquid compound onto the contact surface does not produce the desired result. In this case, atomization of the fluid stream in order to produce a spray pattern as commonly required.

Atomization of a fluid can be achieved either by pumping the fluid through an orifice at high pressure using an apparatus specifically designed to create atomization, or, alternatively, by air atomization.

Air atomization is a known process, where, as the stream of fluid under low pressure exits the dispensing device, the fluid stream is enveloped by pressurized air delivered to the fluid exit point to form droplets in a defined pattern. It is known in the prior art to attach an air nozzle assembly to the exit point of a delivery tube of a dispensing device in order to achieve air atomization.

Prior art devices typically deliver the pressurized air to the air nozzle assembly through an air conduit in the form of a flexible hose or tube positioned externally along the entire length of the delivery tube of the dispensing device. The air conduit typically terminates at the air nozzle assembly. Accordingly, the entire apparatus takes up a large amount of space, making the dispensing device cumbersome, awkward to disassemble, and difficult to operate in tight spaces, such as inside a small mold cavity, or in crevices.

### SUMMARY OF THE INVENTION

The invention provides external air atomization of the fluid, external of both the air cap and fluid tip components and in the case of both two-piece and one-piece constructions, the swirling air does not contact the fluid within the nozzle.

The invention provides an external air atomization nozzle (one piece) specially suited for two component, statically mixed fluids. The nozzle is made to impart a rotational or swirling action of air within the air chamber of the body, surrounds the fluid tip at the distal end of the nozzle. The rotational axial flow of pressurized air exits the nozzle, creating a vortex effect as it surrounds the fluid stream, causing a breakup of the fluid stream into fine droplets.

Specifically, the invention provides an atomizing air nozzle assembly for attachment to a fluid dispensing gun, the fluid dispensing gun comprising a body having at least one fluid inlet for receiving a pressurized fluid and an air inlet for receiving pressurized air and an elongated barrel having a proximal end proximate to the at least one fluid inlet and the air inlet, and a distal end, the barrel having a longitudinal fluid delivery tube extending between the proximal and distal ends of the barrel in fluid communication with the at least one fluid inlet, and a plurality of air passageways extending between the proximal and distal ends of the barrel in fluid communication with the air inlet. The fluid delivery tube has a distal end with an opening at the distal end of the barrel. The air nozzle assembly comprises a fluid tip and an air cap, the fluid tip having proximal and distal ends, the fluid tip comprising a fluid tip chamber configured to sealingly encompass the distal end of the fluid delivery tube in fluid communication with the fluid delivery tube. The fluid tip chamber has an orifice at the distal end of the fluid tip configured to allow fluid passing from the fluid delivery tube into the fluid tip chamber out though the orifice. The air cap has proximal and distal ends and is configured to receive, through the proximal end of the air cap, the distal end of the fluid tip, and sealingly attach to the distal end of the barrel. The air cap comprising an air channel configured to receive the pressurized air from the air passageways of the barrel and pass the pressurized air to a distal radial vane swirl chamber in the air cap having an annular opening in the distal end of the air cap surrounding the fluid tip orifice. The swirl chamber in the air cap has multiple stationary rotational flow air vanes configured to redirect the pressurized air from an axial flow to a radial flow before exiting the air cap though the annular opening.

The radial vane swirl chamber is configured to redirect the pressurized air from an axial flow to a radial flow perpendicular to the fluid tip before exiting the air cap though the annular opening.

Preferably, the air cap and fluid tip are integrally formed.

The air cap may be threadably connectable to a threaded inner surface of the distal end of the gun barrel.

The invention provides an atomizing air nozzle assembly for attachment to a fluid dispensing gun having a barrel having a fluid delivery tube, the air nozzle assembly comprising a fluid tip and an air cap. The fluid tip has proximal and distal ends, and a fluid tip chamber configured to sealingly encompass the fluid delivery tube of the fluid dispensing gun. The fluid tip chamber has an orifice at the distal end of the fluid tip configured to allow fluid passing from the fluid delivery tube through an opening in the fluid delivery tube into the fluid tip chamber and flow out through the orifice. The air cap has proximal and distal ends and is configured to receive, through the proximal end of the air cap, the distal end of the fluid tip, and sealingly attach to the distal end of the barrel. The air cap has an air channel configured to receive the pressurized air from air passageways of the fluid dispensing gun and pass the pressurized air to a distal radial vane swirl chamber in the air cap having an annular opening in the distal end of the air cap surrounding the fluid tip orifice. The air cap has multiple stationary rotational flow air vanes configured to redirect the pressurized air from an axial flow to a radial flow before exiting the air cap through the annular opening. The air cap and fluid tip may be integrally formed.

The invention also provides an atomizing air nozzle for attachment to a fluid delivery tube. The air nozzle has a fluid tip and an air cap that are integrally formed. The fluid tip has proximal and distal ends, and has a fluid tip chamber configured to sealingly encompass the distal end of the fluid delivery tube. The fluid tip chamber has an orifice at the distal end of the fluid tip configured to allow fluid passing from the fluid delivery tube through an opening in the fluid delivery tube into the fluid tip chamber and flow out through the orifice. The air cap has proximal and distal ends and surrounds the distal end of the fluid tip. The nozzle is sealingly attachable to the fluid delivery tube. The air cap has an air channel configured to receive the pressurized air and pass the pressurized air to a distal radial vane swirl chamber in the air cap having an annular opening in the distal end of the air cap surrounding the fluid tip orifice. The air cap has multiple stationary rotational flow air vanes configured to redirect the pressurized air from an axial flow to a radial flow before exiting the air cap though the annular opening. The nozzle may be adhesively attached to the fluid delivery tube. The air nozzle may be threadably attached to the fluid delivery tube. The nozzle may be integrally formed with the fluid delivery tube or may be attached to the fluid delivery tube by other known means of attachment.

### BRIEF DESCRIPTION OF THE DRAWINGS

FIG. 1 is a cross-sectional view of an embodiment of a spray gun with an atomizing air nozzle assembly attached thereto.

FIG. 2 is an expanded view of item B in FIG. 1 showing a cross-sectional view of the atomizing air nozzle assembly attached to the inner surface of the distal end of the barrel of the spray gun.

FIG. 3 is a cross-sectional view of the atomizing air nozzle assembly of FIG. 1 showing the fluid tip inserted into the air cap.

FIG. 4 is a cross-sectional view from the perspective of line S - S of FIG. 3.

FIG. 5 is a cross-sectional view of another embodiment of an atomizing air nozzle assembly with the fluid tip integrally formed with the air cap.

FIG. 6 is a cross-sectional view from the perspective of line C - C of FIG. 5.

FIG. 7 is a cross-sectional view of a third embodiment of an atomizing air nozzle assembly.

FIG. 8 is a cross-sectional view from the perspective of line D - D of FIG. 7.

FIG. 9 is a cut-away perspective view of an embodiment of an air cap.

FIG. 10 is a front perspective view of an embodiment of an air cap with a portion of the front of the air cap cut away to show vanes of the air cap surrounding the output orifice of the fluid tip inserted therein.

FIG. 11 is a front perspective view of an embodiment of an air cap with a portion of the front of the air cap cut away to show vanes of the air cap.

FIG. 12 is a rear perspective view of a spray gun with three fluid inlet ports and one air inlet.

### DESCRIPTION OF THE INVENTION

The present invention is an atomizing air nozzle assembly 35 for use with a spray gun that preferably utilizes a static mixing tube 32, preferably for mixing multiple component materials such as those used to produce polyurethane protective coatings that gel after mixing within seconds and effectively cure as a solid membrane. The same principle of mixing is also used for coatings such as slower curing epoxies, among other coatings that require mixing immediately before application.

It is an object of the invention to provide an improved fluid atomization nozzle 35 for high viscosity fluids.

A known limitation of existing spray nozzles for highly viscous fluids in the viscosity range of 1,000 centipoise and higher is the inability to effectively reduce the droplet size to be fine enough and uniform in size so that a satisfactory spray pattern can be produced.

One such application is a spray-on truck liner whereby a multiple component polyurethane material is sprayed onto the truck bed surface to create a thick, protective coating or membrane.

One way of spraying such coating materials is by means of high-pressure spray machinery where the component liquids are heated above 140 degrees Fahrenheit (60 degrees Celsius) to reduce the viscosity and then the liquid streams are pumped at very high pressure, for example exceeding 2,000 PSI (137 Bar), through an apparatus and spray nozzle designed to create a fine, spray pattern with a small droplet size. Such high pressure machines are significantly more expensive, require much more electrical power and are not well suited for small applications.

It is known in the art related to spray nozzles that a surrounding air stream more effectively atomizes the fluid into a spray pattern of fine droplets when the air stream swirls around the fluid stream, creating a vortex.

A known method of causing the pressurized air to swirl is to direct the air along a helical channel or passage to create a spiraling effect. This method is effective at atomizing the fluid stream but limited in reducing the velocity of the air and atomized fluid material. The pressure and velocity of the air required to effectively create a fine droplet spray pattern with high viscosity fluids continue to be problematic. The applicator is forced to spray from a greater distance from the surface being coated which results in overspray and waste of material.

The present invention utilizes a stationary, radial vane swirl chamber 75, formed internally within the body of the air cap 71. The pressurized air is temporarily redirected inside the air cap 71, through radially positioned air vanes 77 angled perpendicular to the fluid tip 61. The air stream is transformed from an axial flow to a radial flow, without flowing in the axial direction during the transition, causing a highly effective, low velocity air vortex prior to exiting the nozzle and surrounding the fluid stream.

The present invention is intended for use with low-pressure spray machinery to produce an equally fine, small uniform droplet size spray pattern using a small volume of pressurized air (less than 2 CFM), low air pressure, in a range from 85-100 PSI (6-7 BAR) and a fluid pressure exiting the fluid tip of less than 100 PSI (7 BAR).

A low-pressure fluid atomization nozzle 35 for high viscosity fluids comprises a minimum of two components, a fluid tip 61 and radial vane air cap 71, which optionally may be integrally formed as one integral piece. The fluid tip 61 is the conduit for the liquid being pumped at low pressure and the air cap 71 encompasses the distal end of the fluid tip 61, creating a radial vane swirl chamber 75 for pressurized air to surround the nose 65 of the tip and exit the nozzle assembly though an annular opening 73, independent of the fluid stream, immediately surrounding the fluid stream exiting thought the orifice 63 of the fluid tip 61. Upon contact with the fluid stream, the stream is broken into droplets, thereby creating a spray pattern, which is typically a conical shaped pattern.

The atomizing air nozzle assembly 35 includes an air cap 71 that incorporates a series of preferably integrally molded, stationary angular air vanes 77 that change the axial flow of pressurized air into a circular air flow immediately prior to exiting the air cap 71 through the annular opening 73 and engaging the fluid stream exiting via the fluid tip orifice 63, breaking the fluid stream into a smaller and more consistent size of droplets. By changing the air flow from an axial flow to a rotational air flow, a vortex of swirling air immediately encompasses the fluid stream, causing the fluid stream to break up in a predictable fashion, based on the surface angle of the fluid tip in concert with the internal air cap surface.

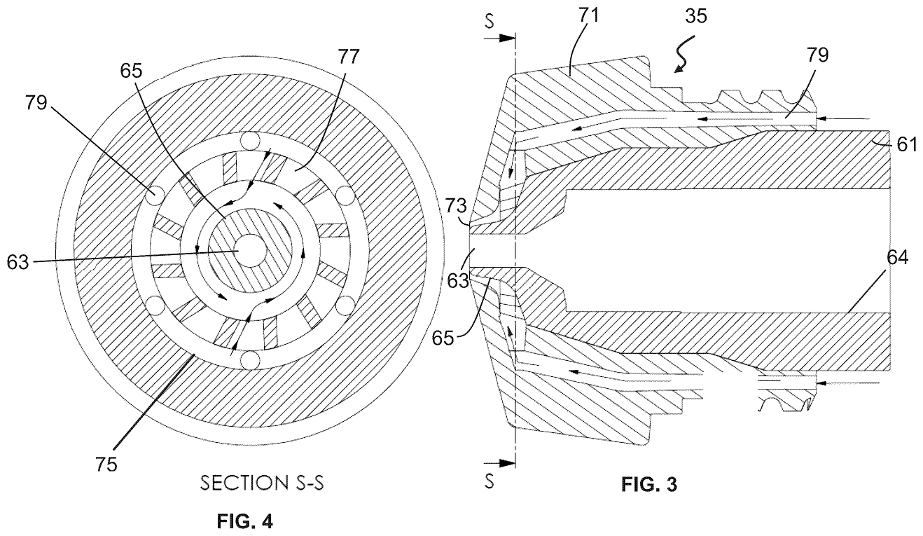

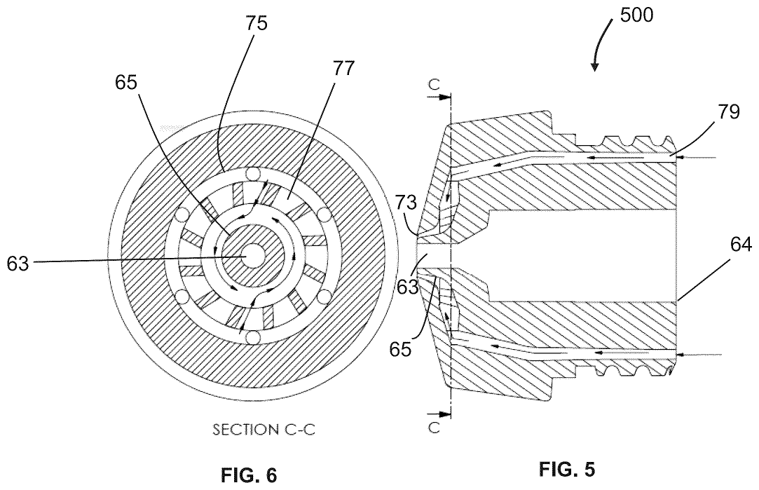

The present invention preferably utilizes 3D photopolymer print technology, also known as additive manufacturing. The invention utilizes the ability to form small holes that follow the internal wall of the polymer air cap, thereby eliminating the restraints of conventional machining. The pressurized air passageway 79 (see FIGS. 3 and 5) through the air cap body is directed in multiple holes or channels to a distal air swirl chamber 75 on the periphery of the stationary air vanes 77 that direct the air in a circular direction and inward to the outer surface of the fluid tip 61, exiting the air cap through an annular opening 73 in a swirling, rotational flow, parallel to the fluid stream exiting though the fluid tip orifice 63, creating a vortex of the air and fluid combination.

A preferred embodiment of the invention is the simplification of making a single integrally formed component spray nozzle 500 (see, e.g., FIG. 5) comprising all of the elements of the two-piece spray nozzle assembly, which reduces cost and also reduces the complexity of pairing separate air cap 71 and fluid tip 61 components in an assembly requiring precise mating surfaces.

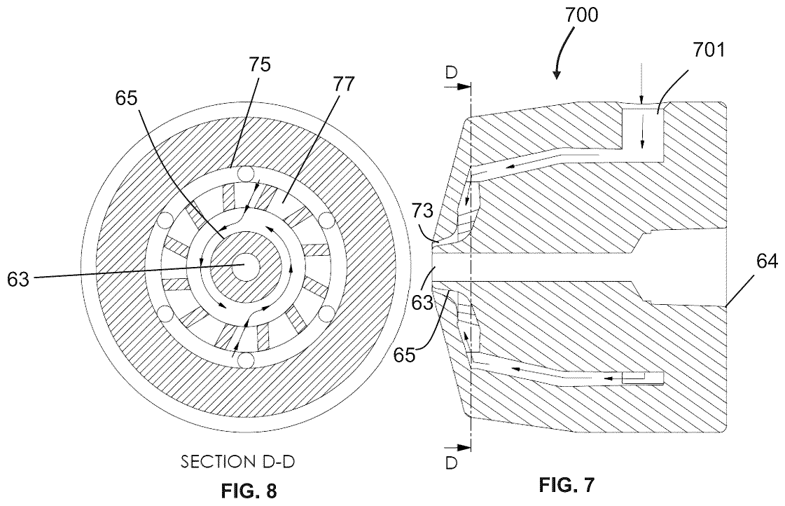

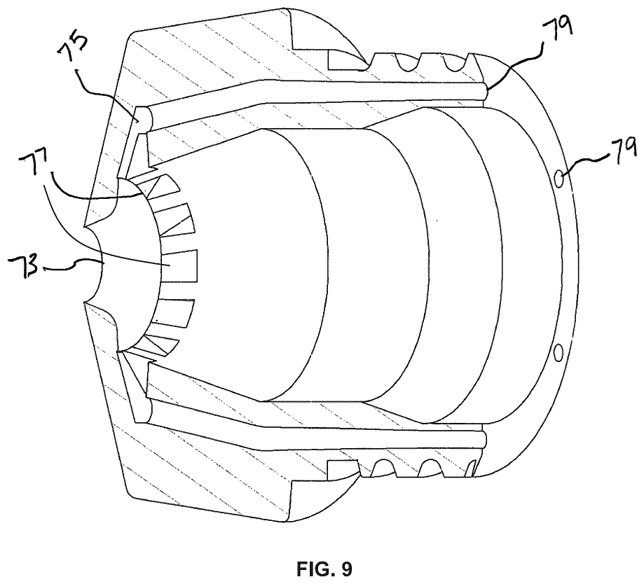

FIG. 7 and cross-sectional view in FIG. 8 show another embodiment of an integrally formed nozzle 700 where the air enters the nozzle through a vertical opening 701.

Although the purpose of the invention is to more effectively and efficiently atomize high viscosity fluids, the advantages of utilizing radially positioned air vanes 77 to create a rotational air flow and thereby create a vortex could be utilized for virtually any type of fluid atomization with pressurized air or gas.

The present invention provides a method used to atomize fluids delivered to the spray nozzle 35, 500 through a static mix tube 32, however, the invention can be utilized to atomize most any fluid delivered to the spray nozzle 35, 500.

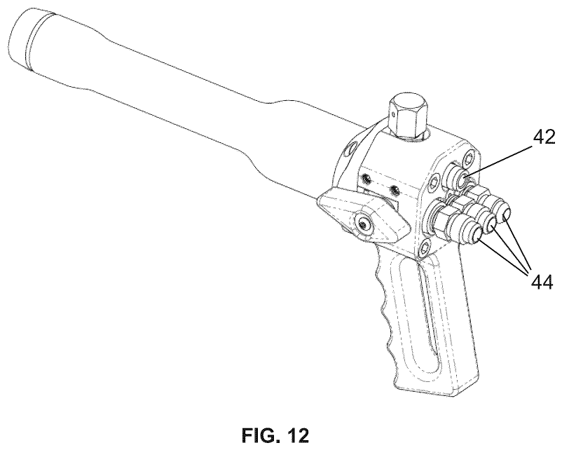

The present invention may also be used to blend and disperse two or three, as shown in FIG. 12 (or one or more than three), individual flows of liquids or gases.

A person skilled in the art would understand that various angles and shapes of vanes 77 may be used to create variations of turbulence. The orifice sizes and geometry may also be modified to cause the desired outcome.

The invention may also be manufactured with materials such as high temperature polymers, stainless steel or titanium as 3d print technology is advancing in its broad range of materials and high precision.

The invention comprises a conventional spray/fluid dispensing gun with a novel spray nozzle 35, 500. The spray gun may be similar to the spray gun disclosed in U.S. Pat. No. 6,131,823, which is hereby incorporated herein by reference.

FIG. 1 shows a preferably cylindrical body 1 of a fluid dispensing/spray gun with a preferably integral handle portion 2 projecting downwardly from the body. The body and handle are manufactured from any suitable material, such as, for example, aluminum. Preferably, two fluid inlet structures, such as conventional pressurized fluid material inlet ports 44, are sealably secured within corresponding openings 3 within the rear portion of the body. In some embodiments three fluid inlet ports may be present, as in FIG. 12, or only one fluid input port may be present. The inlet ports are secured in any suitable fashion, such as, for example by threadably engaging a corresponding threaded portion of the openings. For example, one fluid inlet port 44 may be connected to a supply of isocyanate and the other to a supply of polyol, which are mixed within the gun in order to form a reactive mixture. The fluids to be mixed are delivered to the inlet ports 44 by conventional pumps (not shown) and the pressure is regulated by any known means, such as, for example, computer controls (not shown). The fluid material inlet ports 44 are in fluid communication with corresponding fluid inlet channels 4, which run through the body of the gun, exiting at a front “nose” section 15 adapted to sealably engage a fluid delivery tube 32.

An air inlet structure 42, such as a needle valve assembly, is secured within a corresponding recess within the rear portion of the body and is in fluid communication with an air inlet channel 6 also running through the body generally parallel to the fluid inlet channels. The flow of the pressurized air is regulated by any suitable means, such as a needle valve 7.

The spray gun has a preferably generally cylindrical aluminum barrel assembly 10 projecting outwardly from the body 1. Preferably, the outer sleeve 40 of the barrel is threadably secured to, although may be integrally formed with, the body, and the connection may be sealed by an O-ring. A preferably plastic generally cylindrical fluid delivery tube 32 is nested within the sleeve 40. The interior of the tube defines a longitudinal fluid passageway through the barrel. When the sleeve is secured to the body, a bell-shaped first end 33 of the tube is pressed against the “nose” section 15 of the body, such that a seal is established between the body and the tube. The fluid inlet channels 4 are then also in fluid communication with the delivery tube.

Preferably, when there are two or more fluid inlets 44, a mixing structure, such as a conventional removable plastic mixing element 36 of a spiral or helical configuration, is disposed along the length of the fluid delivery tube. The shape of the mixing element can be varied depending on the fluids to be mixed and the type of mixing required.

An air channel 21 is machined within the barrel assembly 10 such that when the barrel is threadably secured to the body 1, the air channel aligns and is in fluid communication with the air inlet channel 6. The air channel 21 is also in fluid communication with a longitudinal air passageway defined within the barrel assembly. The longitudinal passageway is preferably a circular air conduit 21 defined by the outer surface of the fluid delivery tube 32 and the inner surface of the sleeve 40.

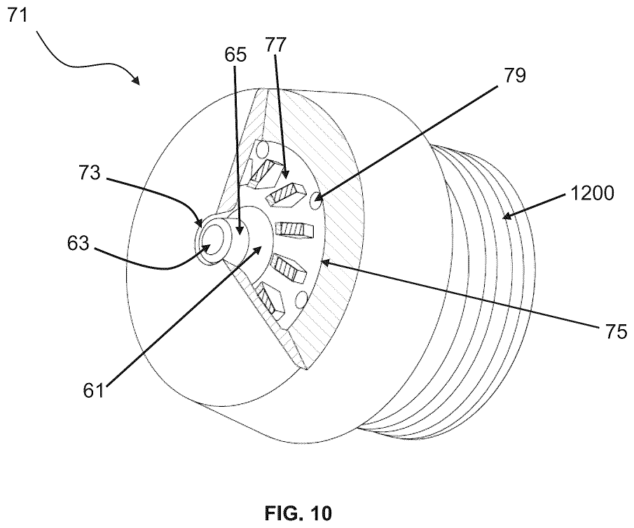

The air cap 71 incorporates a series of integrally molded, stationary angular air vanes 77 that change the axial flow of pressurized air into a circular air flow immediately prior to exiting the air cap 71 and engaging the fluid stream, and more easily breaking the fluid stream so that it has a smaller and more consistent size of droplets. The air cap 71 may threadably engage the inner surface of the distal end of the sleeve of the barrel 40 via threads 1200 (see FIGS. 10 and 12) on the proximal end of the air cap 71 and the inner surface of the distal end of the sleeve. By changing the air flow from an axial flow to a rotational air flow, a vortex of swirling air immediately encompasses the fluid stream, causing the fluid stream to break up in a predictable fashion, based on the surface angle of the fluid tip in concert with the internal air cap surface.

The atomizing air nozzle assembly 35, is sealably secured to the distal end of the barrel assembly 10 where the pressurized air and the fluid mixture stream exit the dispensing gun through the annular opening 73 and fluid tip orifice 63 respectively. The air nozzle is secured to the barrel assembly in any suitable fashion, such as threadably engaging a corresponding threaded portion 200 of the inner surface of the outer sleeve 40.

During operation, the two fluids to be mixed are generally delivered under pressure of less than 200 PSI to the corresponding fluid inlet ports 44. The fluids travel through the body 1 via the fluid inlet channels 4, and enter the fluid delivery tube 32. The fluids are mixed by the mixing element 36, which continually divides and recombines the fluids in the delivery tube to achieve thorough mixing. The relative concentrations of the two fluids can be adjusted to achieve an appropriate chemical reaction. Adjustments to the mixture may be made by a number of known means, such as manually altering the flow of each fluid from its pump or by using computer controls.

The pressurized air may be delivered to the needle valve assembly 42 by a conventional air compressor. The air pressure can vary anywhere from 25 PSI to 125 PSI. The flow of the pressurized air is preferably adjusted by a needle valve 7. The air travels through the air inlet channel 6, into the air channel 21 of the barrel 10 and into the pressurized air passageway 79 through the air cap body directed in multiple holes or channels to a radial vane swirl chamber 75 on the periphery of the stationary air vanes.

The fluid or fluid mixture exits the fluid tip orifice 63 as a single stream. The atomization air exits the air nozzle through an annular opening 73, then envelopes the fluid stream with the pressurized air to form droplets which are dispersed in a pre-defined pattern. The spray pattern can be adjusted by restricting the air flow using the set screw 7, by adjusting the air pressure at its source, or by using air nozzles with varying configurations for the fluid and/or air orifices.

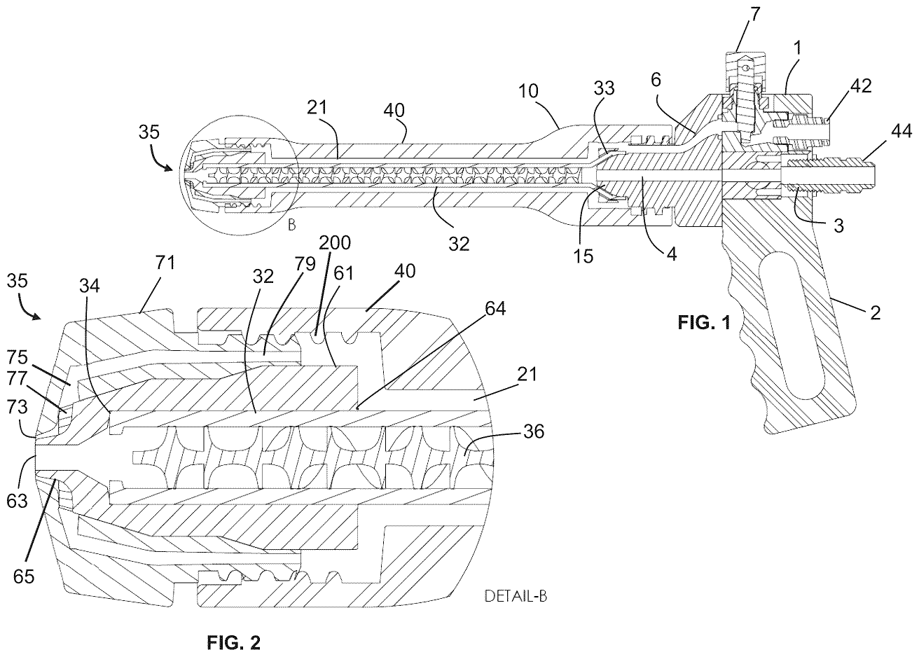

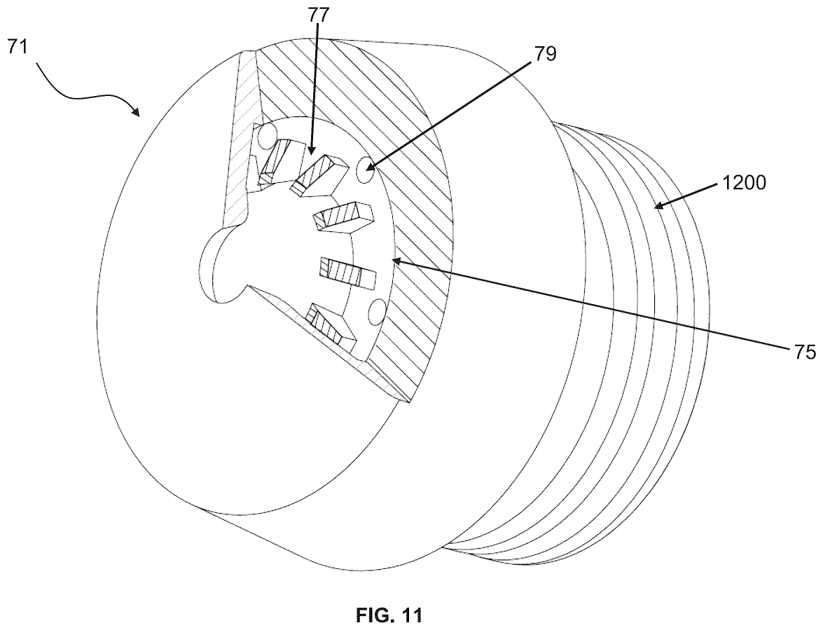

The atomization nozzle 35 comprises an air cap 71 and fluid tip 61 as shown in FIGS. 1-11, which may be integrally formed as in the embodiment shown in FIGS. 5 and 7.

The air cap 71 has a plurality of air channels 79 that direct pressurized air (or gas) from the spray gun barrel 10, through the internal wall of the air cap body 71 to a radial vane swirl chamber 75.

Air vanes 77, preferably integrally formed within the air cap body 71, connect the swirl air chamber 75, with an internal air space between the air vanes 77 and the distal end 65 of the fluid tip 61, when the fluid tip 61 is seated correctly inside the air cap 71.

The air vane walls, are preferably integrally formed within the air cap 71, as radially positioned ribs that form air channels referred to as swirl air vanes 77, that re-direct the pressurized air, from a linear direction, parallel to the axial flow of the fluid, to a direction perpendicular to the fluid tip 61. A key advantage of the swirl chamber is the design flexibility to influence an increase or decrease to air velocity depending on the amount of turbulence required. Using a means of directing the air along a helix doesn't provide as broad a range of control. The pressurized air flows through multiple passageways 79, then enters the swirl chamber 75 and flows through the vanes 77 in a direction perpendicular to the axial flow of the fluid. The air is caused to rotate and swirl while flowing in the perpendicular direction to the fluid and then transitioning once more to an axial direction as a rotational air mass as it contacts the outer surface of the fluid tip 65, and then continues to flow axially through the annular opening 73 of the air cap.

The air vanes 77, perpendicular to the fluid tip nose 65, which comprises a fluid tip chamber, are angled on a tangent to the centerline, when looking at a front face view of the air cap 71.

As the pressurized air is redirected by the air vanes 77, towards the outer surface of the fluid tip 65 the flow of air becomes rotational and exits the cavity, which may be referred to as the inner chamber of the radial vane swirl chamber 75, though an annular opening 73 surrounding the orifice of the fluid tip 61, between the air cap 71 and the fluid tip nose 65, thereby creating a vortex.

The rotational air stream causes the fluid stream to rotate upon convergence of the two, affecting atomization of the fluid to a conical form of droplets.

It should be understood that the above-described embodiments of the present invention, particularly, any “preferred” embodiments or preferred aspects of elements, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein. Any embodiments described herein as “not preferred” are practical embodiments but are considered to be undesirable relative the preferred embodiments described herein.

Where, in this document, a list of one or more items is prefaced by the expression “such as” or “including”, is followed by the abbreviation “etc. ”, or is prefaced or followed by the expression “for example”, or “e.g. ”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

The abbreviation mm as used herein refers to millimetres (or in the US, “millimeters”). The abbreviation cm as used herein refers to centimetres (or in the US, “centimeters”). The abbreviation m as used herein refers to metres (or in the US, “meters”). The unit “mil”means 0.001 inches (0.0254 mm).

Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

It will be appreciated by a skilled person that, where a device is described with multiple components having different and distinct functions and functionalities, such a device further includes any different assignment of functions and functionalities between and among the components that produces a like result. It will be further appreciated that a single component, whether or not explicitly named, recited, or described, may have the functionality ascribed to different components in addition to or in lieu of the operation of those components. It will be further appreciated that the functionality of a single component may be performed by multiple other components, whether or not explicitly named, recited, or described, in addition to or in lieu of the operation of the single component.

It will be appreciated by a skilled person that, where a series of actions, options, steps, or states are described in the context of a method, such a method further includes any different order or permutation of the actions, options, steps, or states that produces a like result. It will be further appreciated that different actions, options, steps, or states of such a method may be performed simultaneously, sequentially, or otherwise.

The terms “about” and “approximately” can be used to include any numerical value that can vary without changing the basic function of that value. It is used to indicate that a specified value should not be construed as a precise or exact value, and that some variation either side of that value is contemplated and within the intended ambit of the disclosure. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5% of the indicated number. For example, unless otherwise stated or implied, “X is approximately equal to and not greater than Y” means that X is between (0.95 times Y) and Y, whereas “X is approximately equal to Y” means that X is between (0.95*Y). and (1.05*Y), unless a skilled person would understand otherwise in the context of the assertion.

Numerical values in the specification and claims of this application should be understood to include numerical values which are the same when reduced to the same number of significant figures and numerical values which differ from the stated value by less than the experimental error of conventional measurement technique of the type described in the present application to determine the value.

The scope of the claims that follow is not limited by the embodiments set forth in the description. The claims should be given the broadest purposive construction consistent with the description and figures as a whole.

What is claimed is:

1. An atomizing air nozzle assembly for attachment to a fluid dispensing gun, the fluid dispensing gun comprising:
a body having at least one fluid inlet for receiving a pressurized fluid and an air inlet for receiving pressurized air; and
an elongated barrel having a proximal end proximate to the at least one fluid inlet and the air inlet, and a distal end, the barrel having a longitudinal fluid delivery tube extending between the proximal and distal ends of the barrel in fluid communication with the at least one fluid inlet, and a plurality of air passageways extending between the proximal and distal ends of the barrel in fluid communication with the air inlet, the fluid delivery tube having a distal end with an opening at the distal end of the fluid delivery tube,
the air nozzle assembly comprising a fluid tip and an air cap, the fluid tip having proximal and distal ends, the fluid tip comprising a fluid tip chamber configured to sealingly encompass the distal end of the fluid delivery tube in fluid communication with the fluid delivery tube, the fluid tip chamber having an orifice at the distal end of the fluid tip configured to allow fluid passing from the fluid delivery tube through the opening in the distal end of the fluid delivery tube into the fluid tip chamber and flow out through the orifice,
the air cap having proximal and distal ends and being configured to receive, through the proximal end of the air cap, the distal end of the fluid tip, and sealingly attach to the distal end of the barrel, the air cap comprising an air channel configured to receive the pressurized air from the air passageways of the barrel and pass the pressurized air to a distal radial vane swirl chamber in the air cap having an annular opening in the distal end of the air cap surrounding the fluid tip orifice, the air cap comprising a plurality of stationary rotational flow air vanes configured to redirect the pressurized air from an axial flow to a radial flow before exiting the air cap though the annular opening.

2. The atomizing air nozzle assembly of claim 1, wherein the radial vane swirl chamber is configured to redirect the pressurized air from an axial flow to a radial flow perpendicular to the fluid tip before exiting the air cap though the annular opening.

3. The atomizing air nozzle assembly of claim 1, wherein the air cap and fluid tip are integrally formed.

4. The atomizing air nozzle assembly of claim 1, wherein the air cap is threadably connectable to a threaded inner surface of the distal end of the gun barrel.

5. The atomizing air nozzle assembly of claim 1, wherein the air cap is adhesively attached to the distal end of the fluid delivery tube.

6. The atomizing air nozzle assembly of claim 1, wherein the gun body has a plurality of fluid inlets and the fluid delivery tube has a mixing element disposed therein.

7. The atomizing air nozzle assembly of claim 1, wherein the gun body has exactly one fluid inlet.

8. An atomizing air nozzle assembly for attachment to a fluid dispensing gun having a barrel having a fluid delivery tube, the air nozzle assembly comprising a fluid tip and an air cap, the fluid tip having proximal and distal ends, the fluid tip comprising a fluid tip chamber configured to sealingly encompass the fluid delivery tube of the fluid dispensing gun, the fluid tip chamber having an orifice at the distal end of the fluid tip configured to allow fluid passing from the fluid delivery tube through an opening in the fluid delivery tube into the fluid tip chamber and flow out through the orifice,
the air cap having proximal and distal ends and being configured to receive, through the proximal end of the air cap, the distal end of the fluid tip, and sealingly attach to the distal end of the barrel, the air cap comprising an air channel configured to receive the pressurized air from air passageways of the fluid dispensing gun and pass the pressurized air to a distal radial vane swirl chamber in the air cap having an annular opening in the distal end of the air cap surrounding the fluid tip orifice, the air cap comprising a plurality of stationary rotational flow air vanes configured to redirect the pressurized air from an axial flow to a radial flow before exiting the air cap though the annular opening.

9. The atomizing air nozzle assembly of claim 7, wherein the air cap and fluid tip are integrally formed.

10. An atomizing air nozzle for attachment to a fluid delivery tube, the air nozzle comprising a fluid tip and an air cap that are integrally formed, the fluid tip having proximal and distal ends, the fluid tip comprising a fluid tip chamber configured to sealingly encompass the distal end of the fluid delivery tube, the fluid tip chamber having an orifice at the distal end of the fluid tip configured to allow fluid passing from the fluid delivery tube through an opening in the fluid delivery tube into the fluid tip chamber and flow out through the orifice,
the air cap having proximal and distal ends the air cap surrounding the distal end of the fluid tip, and sealingly attachable to the fluid delivery tube, the air cap comprising an air channel configured to receive the pressurized air and pass the pressurized air to a distal radial vane swirl chamber in the air cap having an annular opening in the distal end of the air cap surrounding the fluid tip orifice, the air cap comprising a plurality of stationary rotational flow air vanes configured to redirect the pressurized air from an axial flow to a radial flow before exiting the air cap though the annular opening.

11. The atomizing air nozzle of claim 10, wherein the nozzle is adhesively attachable to the fluid delivery tube.

12. The atomizing air nozzle of claim 10, wherein the nozzle is threadably attachable to the fluid delivery tube.

13. The atomizing air nozzle of claim 10, wherein the nozzle is integrally formed with the fluid delivery tube.
